(19) United States
(12) Patent Application Publication
(10) Pub. No.: US 2014/0270304 A1
(43) Pub. Date: Sep. 18, 2014

(54) SPEAKER ASSEMBLY

(71) Applicant: POLY-PLANER GROUP, LLC, New York, NY (US)

(72) Inventors: William R. Pieklik, Baltimore, MD (US); Timothy P. Conroy, Annapolis, MD (US)

(21) Appl. No.: 13/802,148

(22) Filed: Mar. 13, 2013

(51) Int. Cl. H04R 1/02

(52) U.S. Cl. CPC H04R 1/028
USPC 381/334

(57) ABSTRACT

A speaker assembly includes a support member and a frame member. The support member is configured to be attached to a support surface and includes a body portion and a flange. The body portion is configured to pass through an opening in the support surface. The frame member supports at least one audio driver and is configured to be removably attachable to the support member such that the frame member and the at least one audio driver can be removed from a front side of the support member without removing the support member from the support surface.

### INCORPORATION BY REFERENCE

Further components, features, materials, and details of speaker embodiments, that may be used with any of the embodiments disclosed in this application, are found in the following applications and/or patents, which are hereby incorporated by reference in their entireties as if fully set forth herein:

U.S. Pat. No. 8,175,318 (Ser. No. 11/846,970), (titled SPEAKER), filed on Aug. 29, 2007 and U.S. Patent Application Publication No. 2009/0190787 (Ser. No. 12/020,441), (titled SPEAKER), filed on Jul. 25, 2008.

### BACKGROUND OF THE DISCLOSURE

1. Field of the Disclosure

The invention is directed generally to a speaker, and more particularly to a front side serviceable speaker.

2. Background of the Disclosure

Music is becoming more and more a part of everyday life. Many people enjoy listening to music and want to do so in their hot tubs, spas (portable or otherwise), shelves of spas, bathrooms, pools, and other similar recreational and therapeutic devices. For this purpose, speakers and the like are often installed near water sources or in locations exposed to moisture and other elements. However, mounting the speakers in close proximity to water within the hot tub exposes the speakers to chemicals, moisture, and other detrimental elements that can degrade the speaker materials. For example, ozone, chlorine, bromine and other chemical vapors can be present in high concentrations in the gas zone between liquid level and inside of the cover of a spa, where the speakers may be positioned. Such chemical concentrations in the gas zone can be higher than the concentrations of such chemicals in the water.

### SUMMARY OF THE INVENTION

Embodiments disclosed herein relate to, for example, speakers that are mountable to a spa. Any of the features, components, or details of any of the arrangements or embodiments disclosed in this application, including those disclosed below, are interchangeably combinable with any other features, components, or details of any of the arrangements or embodiments disclosed herein to form new arrangements and embodiments. Without limiting the scope of this disclosure, its more prominent features will now be briefly discussed. After considering this discussion, and particularly after reading the section entitled “Detailed Description of Certain Embodiments,” one will understand how the features of the embodiments described herein provide advantages over existing speakers.

An aspect involves a speaker assembly that has a support member configured to attach to a support surface. The support member includes a body portion configured to pass through an opening in the support surface, an opening defined within the body portion, and a flange portion configured to engage the support surface around the opening. The speaker assembly further includes a frame member configured to receive at least one audio driver. The frame member has a body portion and flange portion. The flange portion extends around a perimeter of the body portion. The frame member is removably attachable to the support member from a front surface of the support member such that the frame member and the at least one audio driver can be removed from a front side of the support member without removing the support member from the support surface.

Another aspect involves a method of installing and removing a speaker from a support structure that has an outside surface and an inside surface. The method includes attaching a support member having a body portion and a flange portion to a support structure such that an opening in the support member aligns with an opening in the support structure and providing a frame member supporting one or more audio speakers. The frame member is disposed in the opening of the support member and being releasably coupled to the support member. The method further includes removing the frame member from the support member without removing the support member from the support structure.

Another aspect involves a speaker assembly that has a support member which is configured to be secured to a wall of a spa. The support member defines a receptacle through the wall of the spa. The speaker assembly further includes a frame member that is removably mountable within the support member and configured to receive at least one audio driver. At least a portion of the frame member has a radius greater than a radius of the receptacle so as allow the frame member and the at least one driver to be removed from the support member inside the spa.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The following are brief descriptions of the drawings.

FIG. 1 is an isometric illustration of a speaker assembly in accordance with an embodiment of the present invention.

FIG. 2 is a side view of the speaker assembly illustrated in FIG. 1, taken from a first side.

FIG. 3 is a side view of the speaker assembly illustrated in FIG. 1, taken from a second side.

FIG. 4 is an end view of the speaker assembly illustrated in FIG. 1, taken from an end side.

FIG. 5 is an isometric, exploded view of the speaker assembly illustrated FIG. 1.

FIG. 6 is a side, exploded view of the speaker assembly illustrated FIG. 1.

FIG. 7 is an isometric section view of the speaker assembly illustrated in FIG. 1.

FIG. 8 is an exploded view of the speaker assembly illustrated in FIG. 7.

FIG. 9 is a view of the speaker assembly illustrated in FIG. 7 mounted to a wall surface W.

FIG. 10 is an isometric section view of the speaker assembly illustrated in FIG. 1, wherein a support body of the speaker assembly is mounted to the wall surface W and a portion of the speaker assembly has been removed from the support body.

### DETAILED DESCRIPTION OF CERTAIN EMBODIMENTS

The following detailed description is now directed to certain specific features of the embodiments of a speaker apparatus. In this description, reference is made to the drawings wherein like parts are designated with like numerals throughout the description and the drawings. Also, although the term “spa” is used throughout this description, it is to be understood that the present invention is applicable to a spa, spa enclosure, spa shelf, hot tub, hot tub enclosure, pool, bathroom, and other fluid bearing recreational, therapeutic, or water proximal surfaces or otherwise. Accordingly, as used herein, the term “spa” is to be understood to mean all such fluid bearing recreational or therapeutic devices, as well as the other objects listed above.

Further, it should be readily apparent to one of ordinary skill in the art that, for any speaker apparatus embodiments disclosed herein, such embodiments are not limited to use with a spa. Any speaker enclosure embodiments disclosed herein can be mounted on any surface of any desired object where the user desires an audio speaker system such as, but not limited to, tables, counter-tops, work benches, desks, and other desired surfaces in a user's home, boat, car, or other vehicle, recreational or otherwise.

The speaker embodiments disclosed herein can be configured such that a user or technician can remove the speaker driver from the housing without having to gain access to the backside of the speaker. For example, when speakers are mounted in spas or in walls of other objects, conventional speakers can only be serviced by gaining access to the backside of the speaker, which can require dismantling enclosures to remove the speakers from the back side of such enclosures for service or replacement.

As will be described, the embodiment of the speaker assembly 10 overcome these problems by permitting the speaker components to be removed from the front side of the speaker. In some embodiments, as will be described, speaker components such as the magnet, the cone, the voice coil, the damper, the dust cover, and other related components can be supported within a frame member that can be separately supported by a separate speaker support member that can be fixed to a wall or other support surface. With this two component approach, the driver components of the speaker can be more easily removed for servicing. In this unique configuration, a support member that can be fastened to the wall or other support surface can remain in position after the frame member has been removed from the support member. In some embodiments, the frame member can be configured to support two or more audio drivers.

FIG. 1 is an isometric illustration of an embodiment of the speaker assembly 10, which can have a frame member 12 (see FIG. 5) and a support member 20 configured to support the frame member 12. FIG. 2 is a side view of the speaker assembly 10 illustrated in FIG. 1, taken from a first side. FIG. 3 is a side view of the speaker assembly 10 illustrated in FIG. 1, taken from a second side. FIG. 4 is an end view of the speaker assembly 10 illustrated in FIG. 1, taken from an end side. FIGS. 5 and 6 are an isometric and a side exploded view, respectively, of the embodiment of the speaker assembly 10.

As illustrated therein, the frame member 12 can support the speaker components 13 in a detachable frame (i.e., frame member 12) that can be detached from the support member 20, thereby facilitating servicing of the speaker driver and other components. The support member 20 can be fixed to any desired surface, as will be described below, and the frame member 12 supporting the speaker components can be removably attached to the support member 20. With reference to FIGS. 5-7, in any embodiments disclosed herein, the frame member 12 can be secured to the support member 20 using one or more fasteners, such as screws 40 shown in FIGS. 5 and 6. Threaded receivers or bosses 42 formed in a flange portion 22 of the support member can be used to threadingly receive the fasteners 42 to secure the frame member 12 to the support member 20. The fasteners 40 can be configured to pass through openings 43 formed in the flange portion 14 formed on the frame member 12.

In this configuration, the frame member 12 housing the speaker components can be quickly and easily removably attached to the support member 20. A gasket member 30 or other seal can be positioned between the flange portion 14 of the frame member 12 and the flange portion 22 of the support member 20 to inhibit any water moisture from penetrating the space between the flange portion 14 of the frame member 12 and the flange portion 22 of the support member 20.

Additionally, with reference to the figures, any embodiments of the speaker member disclosed herein 10 can also have a damper holder 60, a plastic ring or frame 50, and a grill 70 positioned over the frame member 12. Finally, if desired, a logo plate 72 can be positioned over the grill 70.

With reference to FIGS. 9 and 10, which are a section view and a partially exploded section view of the embodiment of the speaker assembly 10 mounted to a wall or support surface W, the support member 20 can be secured to a wall surface W. For example, the support member 20 can be secured to the wall surface W using an adhesive, a clip, a fastener, and/or other structure known to a person having skill in the art. In the illustrated embodiment, a support nut 80 is fastened to a body portion 21 of the support member 20. The body portion 21 of the support member 20 can be threaded. An inside surface of the support nut 80 can also be threaded, the support nut being threadable onto the body portion 21 of the support member 20. In some embodiments, a gasket member 90 can be positioned between the flange portion 22 of the support member 20 and a flange portion 82 of the support nut 80. As shown in FIG. 9, the support nut 80 can be tightened against the inside surface W1 of the wall W, while the gasket or sealing member 90 and the flange portion 22 of the support member 20 can be tightened against the outside surface W2 of the wall. Additionally, with reference to FIG. 9, the plastic frame 50 used to support the grill 70 can be configured to latch or fasten to the flange portion 22 of the support member 20.

As shown in FIG. 10, after the support member 20 has been secured to the wall W, as described above, the frame member 12 can then be securely fastened to the support member 20 from the front side F of the support member 20. In this configuration, the support member 20 and the support nut 80 can remain fastened to the wall W of the spa or other object, even after the frame member 12 and speaker components have been removed for servicing or otherwise. Electrical wiring has been omitted for clarity, but would be configured to pass through opening 23 formed in the support member 20.

Any of the components of the speaker assembly 10 can be formed from any suitable materials, including corrosion protected metals, plastics and rubbers such as ethylene propylene diene monomer (EPDM), ABS plastic, Acrylonitrile Styrene Acrylate (ASA) plastic, and otherwise. Additionally, any of the parts disclosed herein can be formed using any suitable processes, including injection molding and otherwise.

As mentioned, the speaker apparatuses described herein are preferably configured to be mounted to any surface of a bathtub, pool, spa, or other water-containing object or water vehicle in any desired position. Additionally, a plurality of speaker apparatuses can be used simultaneously, as well as other audio speaker components such as a receiver, music compact disc player, DVD player, or subwoofer speaker system.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments can be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims.

What is claimed is:

1. A speaker assembly comprising:
a support member configured to attach to a support surface, the support member comprising:
a body portion configured to pass through an opening in the support surface,
an opening defined within the body portion, and
a flange portion configured to engage the support surface around the opening; and
a frame member being configured to receive at least one audio driver, the frame member having a body portion and flange portion, the flange portion extending around a perimeter of the body portion, the frame member being removably attachable to the support member from a front surface of the support member such that the frame member and the at least one audio driver can be removed from a front side of the support member without removing the support member from the support surface.

2. The speaker assembly of claim 1, wherein the support surface is a wall surface of a spa.

3. The speaker assembly of claim 1, wherein the body portion of the support member is threaded.

4. The speaker assembly of claim 1 further comprising a nut configured to attach to the body portion of the support member to secure the support member to the support surface, the nut being positioned on an inside of the support surface and the flange portion of the support member being positioned on an outside surface of the support surface.

5. The speaker of claim 1, wherein the support member attaches to the support surface with an adhesive.

6. The speaker of claim 1, wherein the speaker assembly is configured to be attachable to a spa.

7. The speaker of claim 1, wherein the support surface is a side surface of the spa.

8. The speaker of claim 1, wherein the frame member supports at least two audio drivers configured to provide stereophonic sound.

9. A method of installing and removing a speaker from a support structure having an outside surface and an inside surface, comprising:
attaching a support member having a body portion and a flange portion to a support structure such that an opening in the support member aligns with an opening in the support structure;
providing a frame member supporting one or more audio speakers, the frame member being disposed in the opening of the support member and being releasably coupled to the support member; and
removing the frame member from the support member without removing the support member from the support structure.

10. The method of claim 9, wherein the support structure is a wall surface of a spa.

11. The method of claim 9, wherein the flange portion defines an outwardly facing surface, and wherein the frame member is releasably coupled to the outward facing surface.

12. The method of claim 9 further comprising engaging a nut to the body portion.

13. The method of claim 9, wherein the support member is secured to the support structure with an adhesive.

14. A speaker assembly comprising:
a support member being configured to be secured to a wall of a spa, the support member defining a receptacle through the wall of the spa; and
a frame member being removably mountable within the support member and configured to receive at least one audio driver, at least a portion of the frame member having a radius greater than a radius of the receptacle so as allow the frame member and the at least one driver to be removed from the support member inside the spa.

15. The speaker assembly of claim 14, wherein the at least a portion of the frame member and a portion of the support member define a seal region, the seal region being sized and shaped to receive a gasket member therebetween so as to inhibit liquid from entering the receptacle.

16. The speaker assembly of claim 14, wherein the support member is secured to the spa with adhesive.

17. The speaker assembly of claim 14 further comprising a nut, the nut being secured to the support member via one or more threads from outside the spa.

18. The speaker assembly of claim 14, wherein the support member and the frame member are configured to be coaxially mounted in the wall of the spa.

19. The speaker assembly of claim 14 further comprising one or more fasteners for removably mounting the frame member to the support member, the one or more fasteners being accessible from inside the spa.

20. The speaker assembly of claim 19, wherein the at least a portion of the frame member comprises an opening, the one or more fasteners being configured to pass through the opening.
